(19) United States
(12) Patent Application Publication
(10) Pub. No.: US 2024/0185246 A1
(43) Pub. Date: Jun. 6, 2024

(54) TRANSACTION SUPPORT SYSTEM, TRANSACTION SUPPORT METHOD, AND RECORDING MEDIUM

(71) Applicant: NEC Corporation, Tokyo (JP)

(72) Inventors: Chikako NISHIMURA, Tokyo (JP); Motoyo TANAKA, Tokyo (JP); Maki OOHASHI, Tokyo (JP); Sayuri OTERA, Tokyo (JP)

(73) Assignee: NEC Corporation, Tokyo (JP)

(21) Appl. No.: 18/521,092

(22) Filed: Nov. 28, 2023

(30) Foreign Application Priority Data
Dec. 1, 2022 (JP) 2022-192785

(51) Int. Cl. G06Q 20/40; G06Q 20/10; G06Q 40/02

(52) U.S. Cl. CPC G06Q 20/40145; G06Q 20/1085; G06Q 40/02

(57) ABSTRACT

A transaction support system according to an aspect of the present disclosure acquires transaction information including information about a designated amount, the designated amount being an amount of money designated in a financial transaction through a network, controls to transfer the designated amount of fund in the acquired transaction information from a first account to a second account of a customer of the financial transaction, and notifies the customer of a password required for paying out cash from the second account.

This application is based upon and claims the benefit of priority from Japanese Patent Application No. 2022-192785, filed on Dec. 1, 2022, the disclosure of which is incorporated herein in its entirety by reference.

### TECHNICAL FIELD

The present disclosure relates to a technology for assisting financial transactions.

### BACKGROUND ART

When a financial institution such as a bank performs various transactions with a customer, the transaction is performed by, for example, face-to-face between a staff of the financial institution and the customer at a counter of a store of the financial institution.

In recent years, financial transactions may be conducted via a network. For example, the customer can perform various transactions via an Internet banking system or online interview using a terminal. For example, in an Internet banking system, a customer can transfer money from an account of the customer to an account of another customer by operating a terminal owned by the customer. Reference Literature (Japanese Patent Application Laid-Open No. 2017-059128) discloses a technology related to payment using an Internet banking system.

In a case where a financial transaction is performed via a network, a scene where a customer applies for the transaction may be different from a scene where the customer actually receives cash. Therefore, in a system that performs a financial transaction via such a network, it is necessary to ensure that a customer correctly receives a fund generated in the transaction.

### SUMMARY

An object of the present disclosure is to provide a transaction support system and the like capable of supporting appropriate payment of funds generated in a financial transaction to a customer when the transaction is performed via a network.

A transaction support system according to an aspect of the present disclosure includes: one or more memories storing instructions; and one or more processors configured to execute the instructions to: acquire transaction information including information about a designated amount, the designated amount being an amount of money designated in a financial transaction through a network; control to transfer the designated amount of fund in the acquired transaction information from a first account to a second account of a customer of the financial transaction; and notify the customer of a password required for paying out cash from the second account.

A transaction support method according to an aspect of the present disclosure includes: acquiring transaction information including information of a designated amount, the designated amount being an amount of money designated in a financial transaction; controlling to transfer the designated amount of fund in the acquired transaction information from a first account to a second account of a customer of the financial transaction through a network; and notifying the customer of a password required for paying out cash from the second account.

A non-transitory recording medium according to an aspect of the present disclosure to execute: acquiring transaction information including information of a designated amount, the designated amount being an amount of money designated in a financial transaction; controlling to transfer the designated amount of fund in the acquired transaction information from a first account to a second account of a customer of the financial transaction through a network; and notifying the customer of a password required for paying out cash from the second account.

### BRIEF DESCRIPTION OF THE DRAWINGS

Exemplary features and advantages of the present disclosure will become apparent from the following detailed description when taken with the accompanying drawings in which:

FIG. 1 is a diagram schematically illustrating an example of a configuration including a transaction support system according to a first example embodiment;

FIG. 2 is a block diagram illustrating an example of a functional configuration of the transaction support system according to the first example embodiment;

FIG. 3 is a flowchart for explaining an example of an operation of the transaction support system according to the first example embodiment;

FIG. 4 is a diagram schematically illustrating an example of a configuration including a transaction support system according to a second example embodiment;

FIG. 5 is a block diagram illustrating an example of a configuration of the transaction support system according to the second example embodiment;

FIG. 6 is a diagram illustrating an example of an input form according to the second example embodiment;

FIG. 7 is a diagram illustrating an example of a reservation form according to the second example embodiment;

FIG. 8 is a diagram illustrating an example of a password notification method according to the second example embodiment;

FIG. 9A is a diagram illustrating a first example of customer registration information according to the second example embodiment;

FIG. 9B is a diagram illustrating a second example of the customer registration information according to the second example embodiment;

FIG. 10 is a sequence diagram for explaining an example of an operation of the transaction support system in a reservation phase of the second example embodiment;

FIG. 11 is a sequence diagram for explaining an example of an operation of the transaction support system in a transaction phase of the second example embodiment;

FIG. 12 is a sequence diagram for explaining an example of an operation of the transaction support system in a payment phase of the second example embodiment;

FIG. 13 is a diagram schematically illustrating an example of a configuration including a transaction support system of Modification 3;

FIG. 14 is a block diagram illustrating an example of a configuration of a transaction support system of Modification 5; and

FIG. 15 is a block diagram illustrating an example of a hardware configuration of a computer device that implements the transaction support systems according to the first and second example embodiments of the present disclosure.

### EXAMPLE EMBODIMENT

Next, a detailed explanation will be given for a first example embodiment with reference to the drawings.

### First Example Embodiment

An outline of a transaction support system according to a first example embodiment will be described.

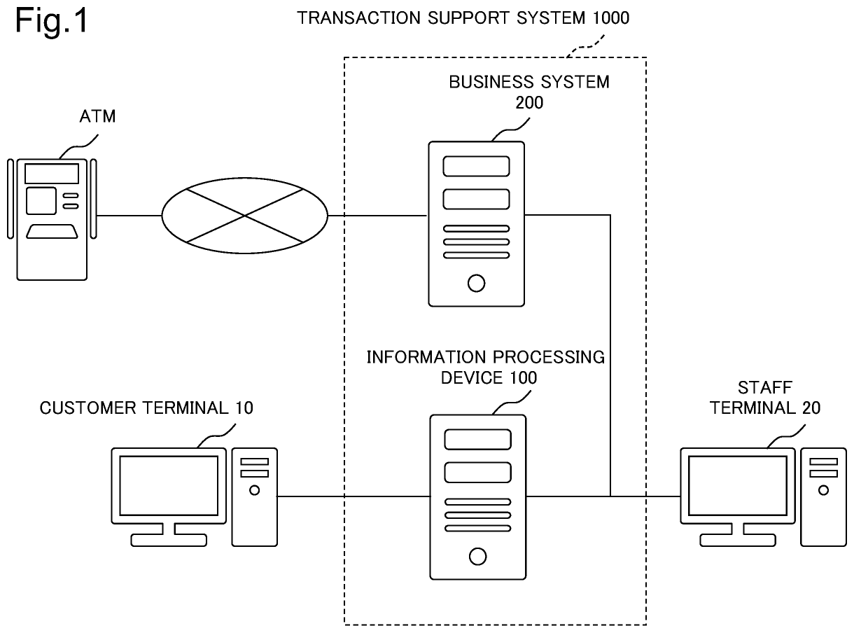

FIG. 1 is a diagram schematically illustrating an example of a configuration including a transaction support system 1000. In the example of FIG. 1, the transaction support system 1000 includes an information processing device 100 and a business system 200. The information processing device 100 is communicably connected to a customer terminal 10 and a staff terminal 20 via a wireless or wired network. The business system 200 is communicably connected to the staff terminal 20 via a wireless or wired network. The business system 200 may be further communicably connected to the information processing device 100. For example, each of the information processing device 100 and the business system 200 may be achieved by a server device. At this time, at least one of the information processing device 100 and the business system 200 may be achieved by a cloud server. That is, the transaction support system 1000 may be achieved as a cloud system. In FIG. 1, the information processing device 100 and the business system 200 are described as being configured by one device for convenience, but the configurations of the information processing device 100 and the business system 200 are not limited to this example. That is, each of the information processing device 100 and the business system 200 may include a plurality of devices.

The customer terminal 10 is a terminal used by a customer. The staff terminal 20 is a terminal used by a staff of a financial institution. The staff of the financial institution is, for example, a bank employee. The present invention is not limited thereto, and the staff of the financial institution may be, for example, a specialized operator. Hereinafter, the staff of the financial institution is also simply referred to as a staff.

The customer terminal 10 and the staff terminal 20 are, for example, personal computers. The customer terminal 10 and the staff terminal 20 may be a smartphone, a tablet terminal, or the like. The customer terminal 10 and the staff terminal 20 include various input devices and output devices. Examples of the input device include a keyboard, a microphone, and a camera. The output device is a display, a speaker, or the like. Specific examples of the customer terminal 10 and the staff terminal 20 are not limited to this example.

The information processing device 100 may be a device that achieves communication between the customer terminal 10 and the staff terminal 20. For example, the information processing device 100 achieves a function of transmitting and receiving audio and video between the customer terminal 10 and the staff terminal 20. For example, the information processing device 100 may control screen display of one of the customer terminal 10 and the staff terminal 20 in response to a request from the other terminal.

The business system 200 is a system that can communicate with an accounting system in a financial institution. The accounting system is a system that manages a ledger (that is, an account ledger) in which transactions such as deposit and withdrawal and settlement are recorded. For example, the business system 200 instructs the accounting system to reflect the transaction in response to a request from the staff terminal 20. For example, it is assumed that a transaction for remitting a predetermined amount from an account of a predetermined person to an account of another person is performed. At this time, a request for remittance of a predetermined amount from an account of a predetermined person to an account of another person is made from the staff terminal 20 to the business system 200 by an operation of the staff. The business system 200 instructs the accounting system to perform the requested remittance. The processing in the business system 200 is merely an example, and the transaction on the accounting system may be reflected by various methods.

An ATM is communicably connected to the accounting system described above through various networks.

Next, an example of a situation in which the transaction support system 1000 in the present application is used will be described. As an example of the situation, a situation in which a customer applies for a transaction to a financial institution through the Internet can be considered. At this time, for example, the customer applies a transaction while making a call with the staff. In short, the customer has an interview with the staff online to conduct the transaction. Specifically, first, communication between the customer terminal 10 and the staff terminal 20 is established. As a result, the customer can talk with the staff using the customer terminal 10. Then, the customer applies a transaction using the customer terminal 10. When the transaction is applied, the staff makes a request relevant to the content of the transaction to the business system 200 using the staff terminal 20. When the processing in response to the request is completed, the staff uses the staff terminal 20 to notify the customer that the transaction has been established. As described above, the transaction support system 1000 serves as at least a part of a system in which a staff of a financial institution and a customer can perform a financial transaction via a network.

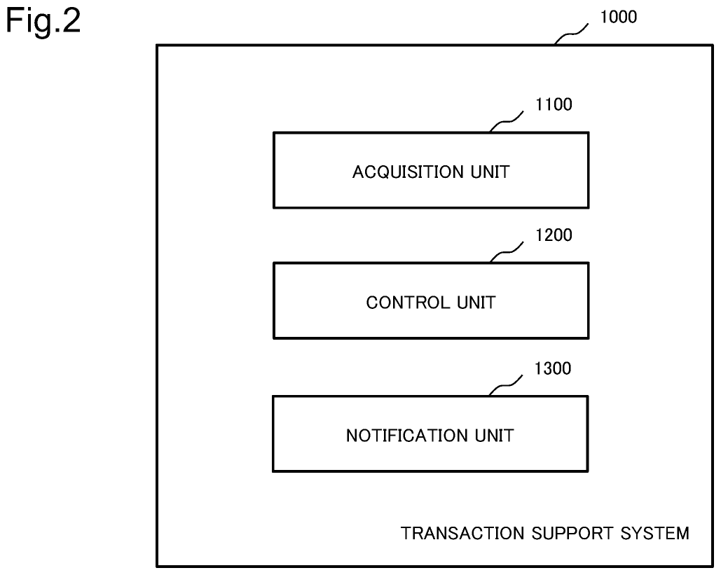

Next, an example of a functional configuration of the transaction support system 1000 will be described. FIG. 2 is a block diagram illustrating an example of a functional configuration of the transaction support system 1000. As illustrated in FIG. 2, the transaction support system 1000 includes an acquisition unit 1100, a control unit 1200, and a notification unit 1300.

The acquisition unit 1100 acquires transaction information indicating the content of the transaction. Here, the transaction is a transaction involving withdrawal. The transaction involving withdrawal in the present disclosure refers to a transaction in which cash is paid out to a customer. Examples of the transaction involving withdrawal include payment of cash from a savings account of a customer and payment of cash associated with cancellation of a time deposit. The transaction information includes information regarding a transaction involving withdrawal. An example of the information regarding the transaction involving withdrawal is information indicating a designated amount which is an amount of money designated in the transaction. That is, the designated amount is an amount of money that the customer desires to pay out in a transaction involving withdrawal.

The acquisition unit 1100 acquires, for example, transaction information from the customer terminal 10. In this case, for example, the customer terminal 10 receives the input of the designated amount from the customer. Then, the customer terminal 10 transmits the information of the input designated amount to the information processing device 100. In this manner, the acquisition unit 1100 may be included in the information processing device 100.

The acquisition unit 1100 may acquire transaction information from the staff terminal 20. In this case, for example, the customer notifies the staff of the designated amount by telephone call. Then, the staff terminal 20 receives the input of the designated amount from the staff. Then, the acquisition unit 1100 may receive information of the designated amount from the staff terminal 20. In this example, the acquisition unit 1100 may be provided in either the information processing device 100 or the business system 200.

In this manner, the acquisition unit 1100 acquires the transaction information including the information of the designated amount that is the amount of money designated in the transaction. The acquisition unit 1100 is an example of an acquisition means.

The control unit 1200 performs control to transfer the fund based on the transaction information. Specifically, the control unit 1200 performs control to transfer the designated amount of fund indicated in the transaction information from the first account of the customer to the second account. The first account is an account of a withdrawal source. For example, in a case where the transaction is payment of cash from a savings account, the first account corresponds to the customer's savings account. In addition, the first account may be a reserving deposit account or the like. The second account is an account associated with customer identification information for identifying a customer, and is an account that can be managed differently from the first account. At this time, the second account may be an account different from the first account, or an account set in an area logically divided in the first account. An example of the second account is an account for each purpose. The customer identification information is, for example, information of a character string assigned to a customer in a financial institution, but may be an account number of the first account or the like. For example, the control unit 1200 requests the accounting system to transfer the designated amount of fund from the first account to the second account.

In this manner, the control unit 1200 controls to transfer the designated amount of fund indicated in the transaction information from the first account to the second account of the customer. The control unit 1200 is an example of a control means.

The notification unit 1300 notifies the customer of a password for paying out cash from the second account. A password dedicated to the second account is set to the second account. For example, when the customer pays out cash from the second account using the ATM, the customer inputs the password to the ATM. As a result, cash is paid out at the ATM. The password may be a password used only for withdrawal from the second account. For example, a passcode is usually set in the savings account. When the first account is the savings account, the password set to the second account may be information different from the passcode relevant to such a first account.

For example, the notification unit 1300 may notify the customer terminal 10 by transmitting a password. At this time, the notification unit 1300 may transmit information that allows access to the password, such as a two-dimensional barcode and a uniform resource locator (URL), to the customer terminal 10. The present invention is not limited to this example, and the notification unit 1300 may notify the password by short message service (SMS) using the telephone number of the customer, or may notify the password by e-mail to the e-mail address of the customer.

In this manner, the notification unit 1300 notifies the customer of the password required for paying out cash from the second account. The notification unit 1300 is an example of a notification means.

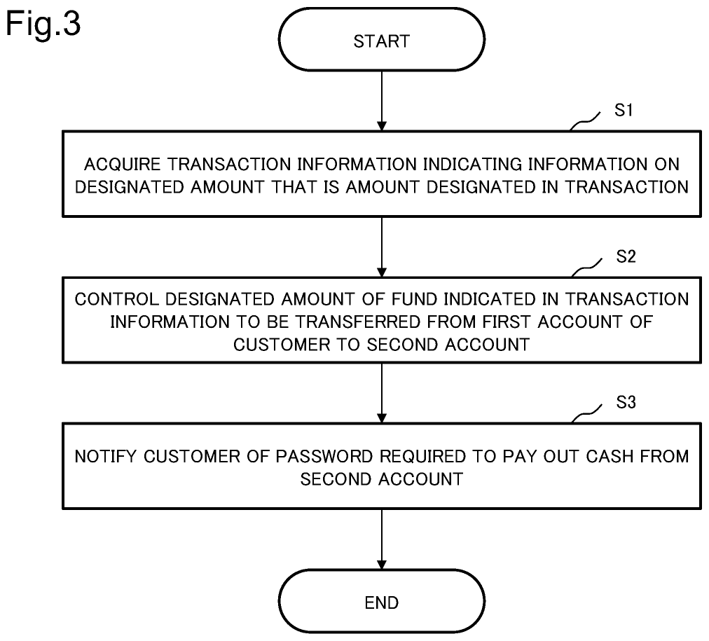

Next, an example of an operation of the transaction support system 1000 will be described with reference to FIG. 3. In the present disclosure, each step of the flowchart is expressed using a number assigned to each step, such as “S1”.

FIG. 3 is a flowchart for explaining an example of an operation of the transaction support system 1000. The acquisition unit 1100 acquires transaction information including information on a designated amount that is an amount of money designated in a transaction (S1). The control unit 1200 controls to transfer the designated amount of fund indicated in the transaction information from the first account of the customer to the second account (S2). The notification unit 1300 notifies the customer of the password required to pay out cash from the second account (S3).

As described above, the transaction support system 1000 according to the first example embodiment serves as at least a part of a system in which a staff of a financial institution and a customer can perform a financial transaction via a network. Then, the transaction support system 1000 acquires the transaction information including the information of the designated amount which is the amount of money designated in the transaction, controls to transfer the designated amount of fund indicated in the transaction information from the first account of the customer to the second account, and notifies the customer of the password required for paying out cash from the second account.

As a result, the transaction support system 1000 can cause cash to be paid to the customer with the password notified at the time of performing the transaction, so that the identity between the customer who applies for the transaction and the customer who receives the cash can be secured. Furthermore, the fund of the second account is the fund generated in the transaction. That is, when cash is paid out to the customer, the transaction support system 1000 can cause the customer to more reliably recognize that the cash is the fund generated by the transaction performed via the network.

That is, in a case where a financial transaction is performed via a network, the transaction support system 1000 can support appropriate payment of the fund generated in the transaction to the customer.

Internet banking is capable of conducting various transactions wherever customers are located. On the other hand, when a customer uses Internet banking, it is necessary for the customer to perform an operation until a transaction is established. Therefore, a customer or the like who is not accustomed to the operation of the Internet banking system may desire a face-to-face transaction. On the other hand, it is conceivable that a customer and a staff of a financial institution face each other in a pseudo manner via a network while making a call or the like to perform a transaction. For example, a customer and a staff have an interview online via a terminal or the like to proceed with a transaction. In such a case, when a transaction involving withdrawal is performed, it is assumed that cash is paid out separately at an automatic teller machine (ATM), a counter of a store, or the like. That is, the scene in which the customer enters the transaction may be different from the scene in which the customer actually receives the cash. Therefore, in a system that performs a financial transaction via such a network, it is necessary to ensure that a customer correctly receives a fund generated in the transaction. According to the present disclosure, in a case where a financial transaction is performed via a network, it is possible to support appropriate payment of funds generated in the transaction to a customer.

### Second Example Embodiment

Next, a transaction support system according to a second example embodiment will be described. In the second example embodiment, a further example of the transaction support system described in the first example embodiment will be described. The description of contents overlapping with the first example embodiment will be partially omitted.

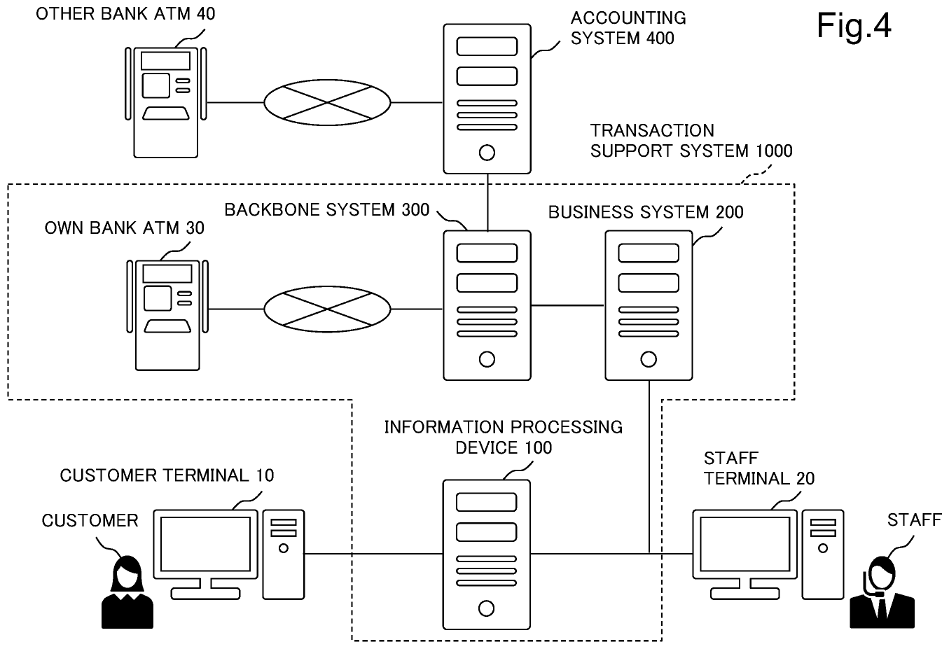

FIG. 4 is a diagram schematically illustrating an example of a configuration including the transaction support system 1000. In the example of FIG. 4, the transaction support system 1000 includes an information processing device 100, a business system 200, a backbone system 300, and an own bank ATM 30. Similarly to the first example embodiment, the information processing device 100 is communicably connected to the customer terminal 10 and the staff terminal 20. The business system 200 is communicably connected to the staff terminal 20.

Further, the business system 200 is communicably connected to the backbone system 300 via a wireless or wired network. The backbone system 300 is a system that controls an account according to an instruction. The backbone system 300 is connected to various systems. In the present example embodiment, the backbone system 300 mediates communication between the business system 200 and the accounting system 400.

The own bank ATM 30 is communicably connected to the backbone system 300 via a wireless or wired network. The own bank ATM 30 is an ATM managed by a financial institution to which a staff using the staff terminal 20 belongs. For example, the own bank ATM 30 is an ATM installed in a store of a financial institution, such as a head office, a branch office, or a sub-branch office of the financial institution.

On the other hand, an other bank ATM 40 is an ATM controlled by another financial institution or the like (hereinafter, referred to as other bank). For example, the other bank ATM 40 is an ATM installed in a store of another bank and an ATM installed in a convenience store. The other bank ATM 40 of the other bank is connected to an accounting system 400 via various networks. For example, the other bank ATM 40 is connected to the accounting system 400 via a backbone system of the other bank different from the backbone system 300. A connection configuration of the other banks ATM 40 will not be described.

In the example of FIG. 4, the information processing device 100, the business system 200, the backbone system 300, and the accounting system 400 are described as being configured by one device for convenience, but each configuration is not limited to this example. That is, each of the information processing device 100, the business system 200, the backbone system 300, and the accounting system 400 may include a plurality of devices.

### [Details of Transaction Support System 1000]

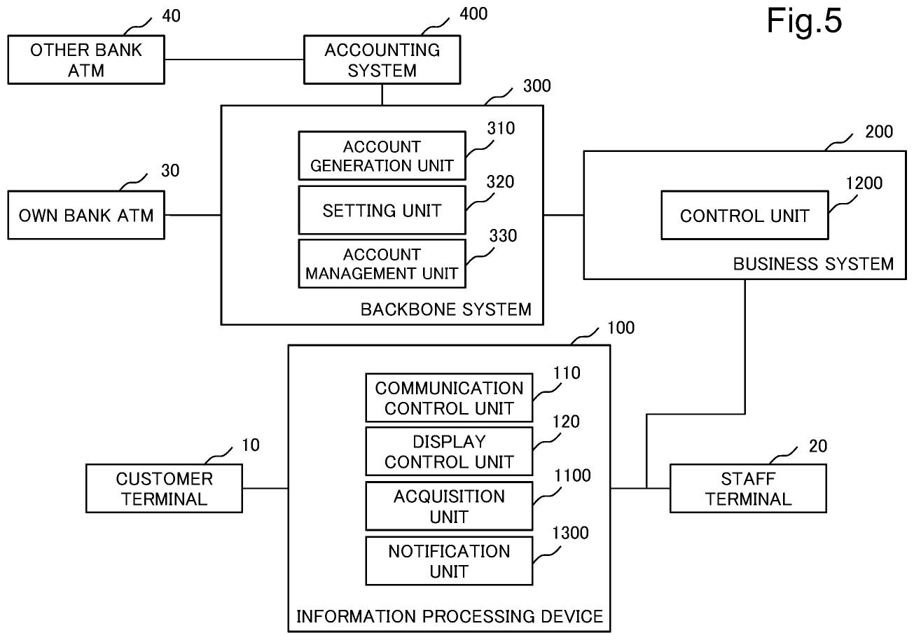

FIG. 5 is a block diagram illustrating an example of a configuration of the transaction support system 1000.

The information processing device 100 includes a communication control unit 110, a display control unit 120, an acquisition unit 1100, and a notification unit 1300.

The communication control unit 110 controls communication for connecting the customer terminal 10 and the staff terminal 20. The communication control unit 110 is an example of a communication control means.

Specifically, the communication control unit 110 has a function of achieving a call between the customer terminal 10 and the staff terminal 20. The call may be a call by only voice or a call by voice and video. For example, each of the customer terminal 10 and the staff terminal 20 is connected to the information processing device 100. Then, the communication control unit 110 transmits the audio data and the video data captured by the staff terminal 20 to the customer terminal 10. The audio data in this case is a voice picked up by the microphone of the staff terminal 20. For example, the audio data includes the voice of the staff. The video data is a video captured by a camera included in the staff terminal 20. For example, the video data includes a video captured by the staff.

Conversely, the communication control unit 110 transmits the audio data and the video data captured by the customer terminal 10 to the staff terminal 20. The audio data in this case is a voice picked up by a microphone included in the customer terminal 10. For example, the audio data includes a voice of a customer. The video data is a video captured by a camera included in customer terminal 10. For example, the video data includes a video in which a customer is photographed. The communication control unit 110 achieves a call between the customer terminal 10 and the staff terminal 20 by exchanging such data.

The display control unit 120 performs display control of the customer terminal 10 and the staff terminal 20. Specifically, the display control unit 120 has a function of causing the customer terminal 10 or the staff terminal 20 to display an input form of various types of information. For example, the display control unit 120 causes the customer terminal 10 to display an input form for accepting the input of the designated amount.

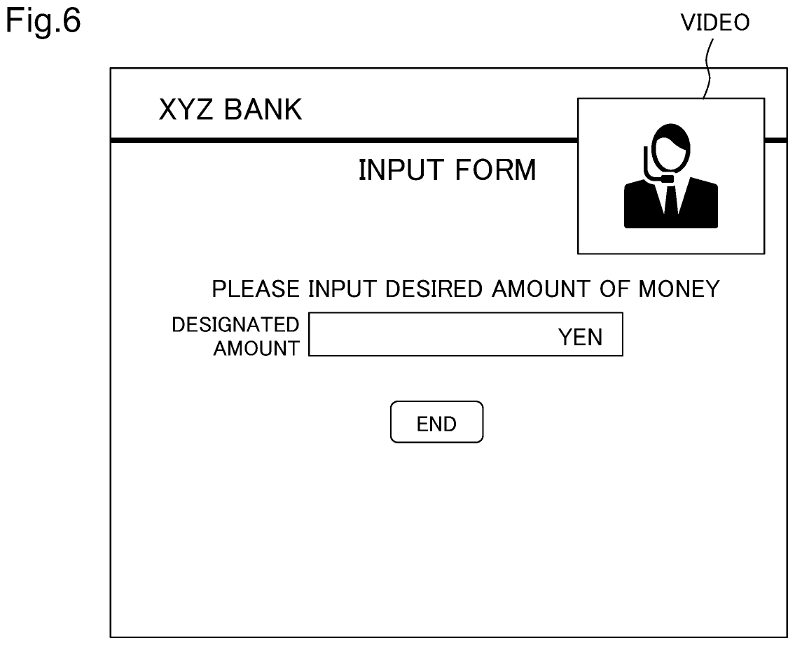

FIG. 6 is a diagram illustrating an example of the input form. FIG. 6 is an example of an input form displayed on the customer terminal 10. In the example of FIG. 6, it is described that the customer is prompted to input the designated amount. The customer inputs the designated amount using the customer terminal 10.

At this time, the display control unit 120 may perform display control of the other terminal in response to a request from at least one of the customer terminal 10 and the staff terminal 20. For example, the display control unit 120 may cause the customer terminal 10 to display an input form for accepting input of a designated amount as illustrated in FIG. 6 in response to a request from the staff terminal 20. As a result, since the information displayed on the customer terminal 10 can be controlled by the operation of the staff, the operation for establishing the transaction can be advanced to the staff side.

In this manner, the display control unit 120 causes the customer terminal 10 to display the input form for accepting the input of the designated amount in response to the request from the staff terminal 20. The display control unit 120 is an example of a display control means.

In the example of FIG. 6, a video showing the staff is displayed superimposed on the input form. The video is a video captured by the staff terminal 20 and controlled by the communication control unit 110. As described above, in the transaction support system 1000, it is possible to prompt the customer to perform various inputs while the customer and the staff have an interview online.

The display control unit 120 may cause the customer terminal 10 to display an input form for accepting input of personal information or the like of the customer. For example, when a customer comes up with the idea of conducting a transaction via a network, the customer reserves an interview for conducting a transaction by accessing a website of a financial institution or the like. The display control unit 120 displays a reservation form for reserving such an interview on the customer terminal 10.

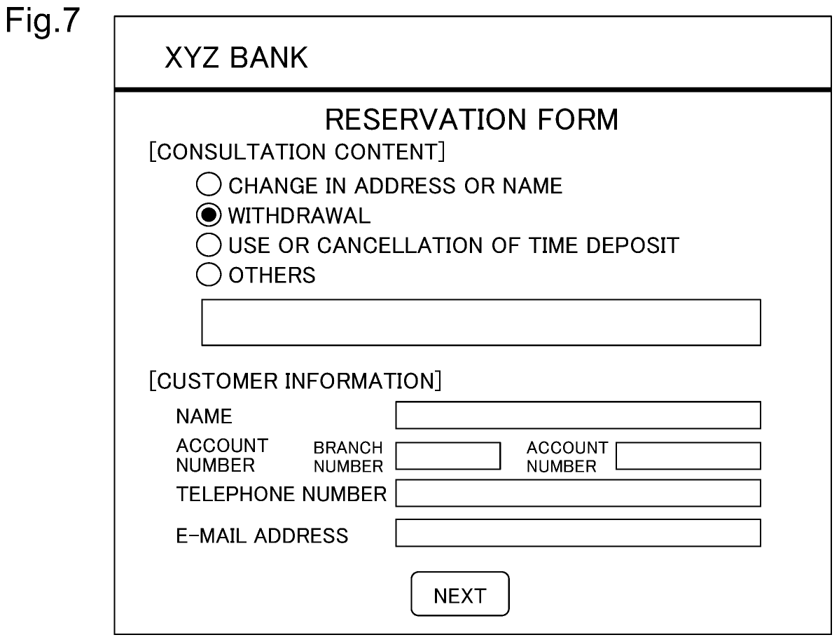

FIG. 7 is a diagram illustrating an example of a reservation form. The example of FIG. 7 illustrates a description for inputting a purpose of transaction as “consultation content” and a description for inputting personal information of a customer as “customer information”. The personal information includes a name, an account number, a telephone number, and an e-mail address, but the personal information may include information other than these. For example, the customer inputs the purpose of transaction, personal information, and the like according to such a reservation form.

The acquisition unit 1100 acquires various types of information. Specifically, the acquisition unit 1100 acquires transaction information regarding a transaction performed between a staff and a customer. For example, it is assumed that an input form as illustrated in FIG. 6 is displayed on the customer terminal 10. The acquisition unit 1100 acquires information indicating the designated amount input in the input form as transaction information.

The transaction information may include personal information of the customer and the like. For example, the acquisition unit 1100 may acquire personal information or the like input to the reservation form illustrated in FIG. 7 as the transaction information.

The notification unit 1300 notifies the customer of information that allows the customer to access the password. The password is set for the second account by a setting unit 320 to be described later. The password is character string information necessary for paying out cash from the second account. For example, the notification unit 1300 performs the notification after the transaction is established.

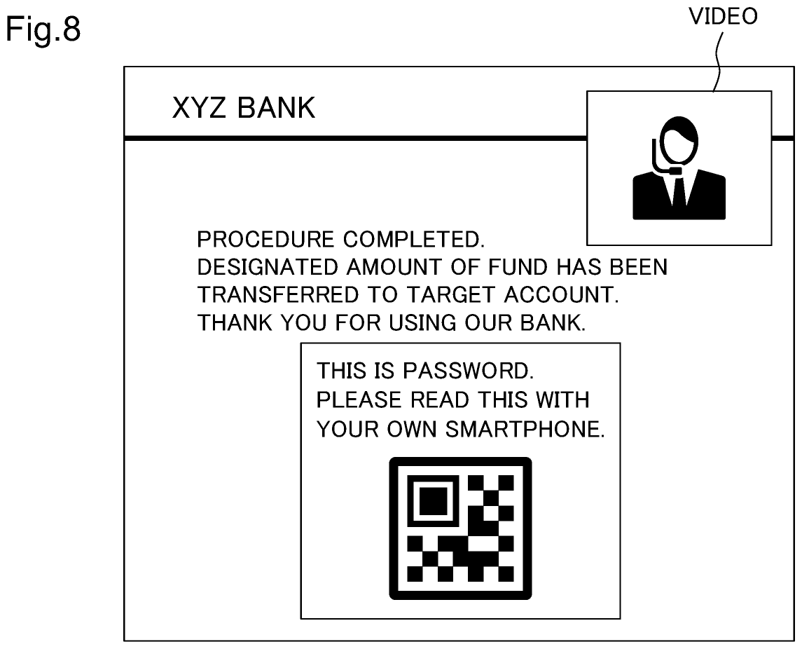

The notification unit 1300 may notify the password by various methods. For example, the notification unit 1300 converts the password into information that allows access to the password. Then, the notification unit 1300 causes the customer terminal 10 to display the converted information. FIG. 8 is a diagram illustrating an example of a password notification method. As illustrated in FIG. 8, for example, the notification unit 1300 may display a two-dimensional barcode accessible to a password on the customer terminal 10. The customer acquires the password by reading the two-dimensional barcode. The notification unit 1300 may display a URL for accessing the password on the customer terminal 10. As described above, the notification unit 1300 may cause customer terminal 10 used by the customer to display information (conversion information) that is obtained by converting the password and that can acquire the password. The notification unit 1300 may display character string information itself, which is a password, on the customer terminal 10.

Not limited to this example, a notification unit 140 may notify the password by, for example, transmitting an e-mail addressed to the e-mail address of the customer. The notification unit 140 may notify the password by transmitting an SMS addressed to the telephone number of the customer.

The business system 200 includes a control unit 1200. The control unit 1200 performs control related to the account of the customer according to the transaction content. Specifically, the control unit 1200 instructs the backbone system 300 to transfer the designated amount of fund from the first account of the customer to the second account. At this time, the control unit 1200 may transmit information indicating the designated amount, customer identification information, and information such as the account number of the first account to the backbone system 300.

The backbone system 300 includes an account generation unit 310, a setting unit 320, and an account management unit 330.

The account generation unit 310 generates various accounts. Specifically, the account generation unit 310 generates an account in response to an instruction from the control unit 1200. Here, the generation of an account by the account generation unit 310 means that information of a new account is registered in customer registration information to be described later in association with customer identification information. For example, it is assumed that the account generation unit 310 receives an instruction from the control unit 1200 to transfer the designated amount of fund from the first account of the customer to the second account. At this time, the account generation unit 310 associates information of the second account that can be managed differently from the first account with the customer identification information of the customer, and registers the information in the customer registration information. An example of the second account is an account for each purpose associated with a savings account owned by the customer.

In this manner, the account generation unit 310 generates the second account. The account generation unit 310 is an example of an account generation means.

The setting unit 320 sets a password in the account. Specifically, when the second account is generated by the account generation unit 310, the setting unit 320 sets a password to the generated second account. The password to be set is predetermined character string information. For example, the character string information includes at least one of a number, an alphabet, and a symbol. The password to be set is information required for withdrawal from the second account. For example, when the customer withdraws cash from the second account using the ATM, it is necessary to input the password.

The password to be set may be generated by the setting unit 320. For example, the setting unit 320 may randomly generate character string information and set the generated character string information as the generated password of the second account. At this time, the setting unit 320 may generate character string information different from the passcode set to the first account.

In this manner, the setting unit 320 sets the password in the second account. The setting unit 320 is an example of a setting means.

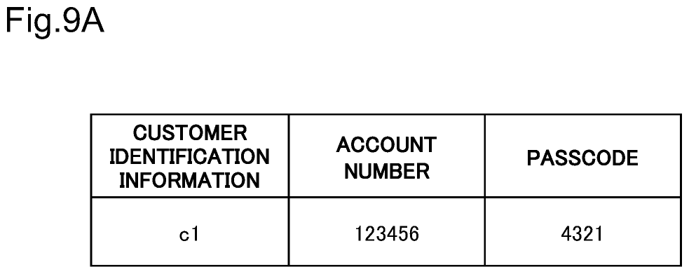

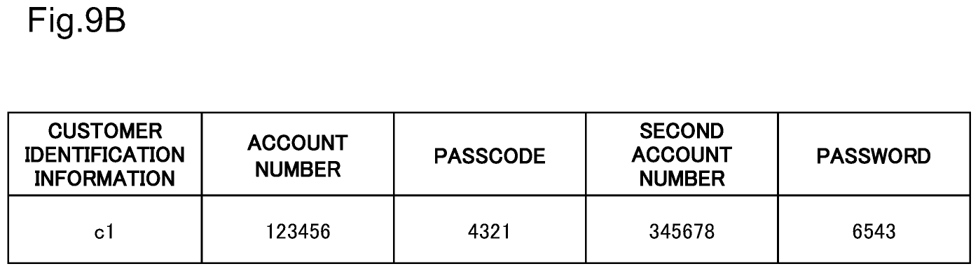

The information regarding the second account is registered in the customer registration information. The customer registration information is a database including information on customers. The customer registration information includes information in which customer identification information, an account number of an account owned by the customer, and a passcode of the account are associated with each other. FIG. 9A is a diagram illustrating a first example of the customer registration information. The example of FIG. 9A indicates that an account with an account number “123456” has been opened for the customer with the customer identification information “c1”. The display also indicates that the passcode of the account with the account number “123456” is “4321”. At this time, the account with the account number “123456” corresponds to the first account.

The account generation unit 310 and the setting unit 320 register information regarding the second account in the customer registration information. FIG. 9B is a diagram illustrating a second example of the customer registration information. For example, when the second account is generated for the customer with the customer identification information “c1”, the account generation unit 310 registers the information regarding the second account in the customer registration information in association with the customer identification information “c1”. In the example of FIG. 9B, information “345678” is added to the record of the customer identification information “c1” as the account number (second account number) of the second account. The setting unit 320 registers the password relevant to the second account in the customer registration information. In the example of FIG. 9B, the password “6543” set to the second account is added to the record of the customer identification information “c1”.

The customer registration information is stored in, for example, a storage device included in the backbone system 300, but is not limited to this example. The customer registration information may be included in a server or the like communicably connected to the backbone system 300.

The account management unit 330 manages accounts. Specifically, the account management unit 330 reflects operations related to various accounts in the accounting system 400. For example, the account management unit 330 causes the accounting system 400 to reflect that the second account has been generated and that the password has been set in the second account.

The account management unit 330 transfers the fund in accordance with the instruction. For example, it is assumed that the control unit 1200 issues an instruction to transfer the fund of 1 million yen from the first account of the customer to the second account. In this case, the account management unit 330 performs control to cause the accounting system 400 to update the balance of the first account of the customer to a value obtained by subtracting 1 million yen. Then, the account management unit 330 performs control to cause the accounting system 400 to update the balance of the second account of the customer to a value increased by 1 million yen. In this manner, the account management means transfers the designated amount of fund from the first account to the second account generated by the account generation unit 310. The account management unit 330 is an example of an account management means.

Further, the account management unit 330 performs control according to a cash payment request from the ATM. For example, it is assumed that the customer uses the own bank ATM 30 to pay out cash from the second account. In this case, the own bank ATM 30 makes a cash payment request related to the second account to the backbone system 300. At this time, the payment request includes information indicating the amount of money. The account management unit 330 performs control to cause the accounting system 400 to update the balance of the second account of the customer to a value obtained by subtracting the amount of money. Then, the account management unit 330 performs control to pay out cash corresponding to the amount of money to the own bank ATM 30.

### [Operation Example of Transaction Support System 1000]

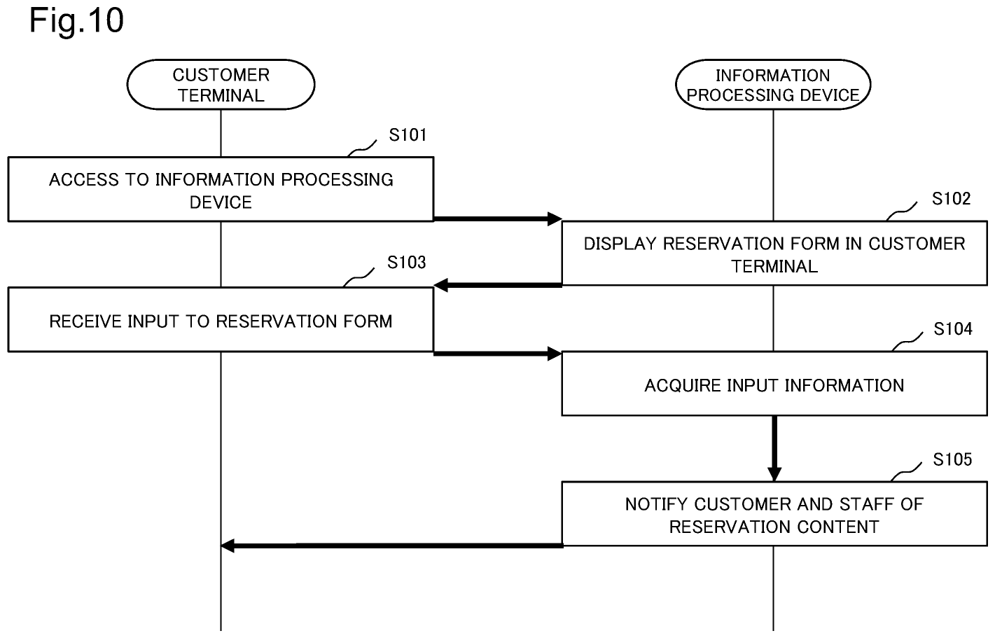

Next, an example of an operation of the transaction support system 1000 will be described. In the present operation example, the operation of the transaction support system 1000 in each of the reservation phase, the transaction phase, and the payment phase will be described with reference to FIGS. 10 to 12. In the present operation example, it is assumed that a transaction for withdrawing 1 million yen in cash from the savings account of the customer is performed.

### [Reservation Phase]

First, an operation of the transaction support system 1000 in the reservation phase will be described. The reservation phase is a scene where a customer reserves an interview with a staff to conduct a transaction. FIG. 10 is a sequence diagram illustrating an example of the operation of the transaction support system 1000 in the reservation phase.

First, the customer terminal 10 accesses the information processing device 100 (S101). For example, the customer reserves an interview from a financial institution's website or the like. At this time, the customer terminal 10 accesses the information processing device 100 by accessing a website or the like for reserving an interview. The display control unit 120 of the information processing device 100 causes the customer terminal 10 to display the reservation form (S102). For example, the display control unit 120 causes the customer terminal 10 to display a reservation form as illustrated in FIG. 7. The present invention is not limited to this example, and the display control unit 120 may further display a reservation form for accepting input of a reservation time for an interview.

The customer terminal 10 receives an input to the reservation form (S103). The acquisition unit 1100 acquires the input information. Examples of the input information include a purpose of transaction, a name of a customer, an account number, a telephone number, an e-mail address, and a reservation time of an interview. For example, the customer inputs that the purpose of the transaction is withdrawal, personal information including his/her account number, and a reservation time for an interview. The acquisition unit 1100 acquires the information input by the customer.

The notification unit 1300 then notifies the customer and the staff of the reservation content (S104). The reservation content includes a reservation time for an interview, a URL for conducting an interview, and the like. For example, communication between the customer terminal 10 and the staff terminal 20 is performed by accessing the URL from the customer terminal 10 and the staff terminal 20.

For example, the notification unit 1300 causes the customer terminal 10 to display the reservation content. The present invention is not limited thereto, and the notification unit 1300 may notify the reservation content to the telephone number of the customer by SMS, or may notify the reservation content by e-mail addressed to the e-mail address of the customer. The notification unit 1300 notifies the staff terminal 20 of the reservation content.

The input information and the information indicating the reservation content are stored in a storage device included in the information processing device 100, a server to which the information processing device 100 and the staff terminal 20 are communicably connected, or the like.

### [Transaction Phase]

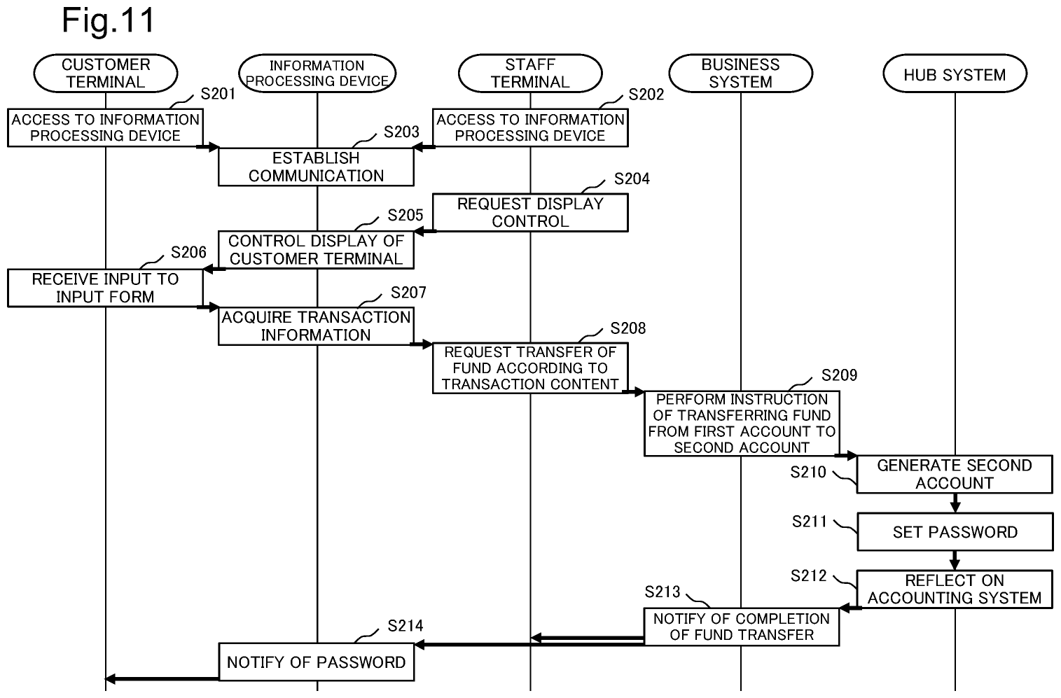

Next, an operation of the transaction support system 1000 in the transaction phase will be described. The transaction phase is a scene where a customer and a staff perform a transaction via a network. FIG. 11 is a sequence diagram for explaining an example of an operation of the transaction support system 1000 in the transaction phase.

First, the customer terminal 10 accesses the information processing device 100 (S201). For example, the customer terminal 10 accesses the information processing device 100 by accessing a URL for conducting an interview at a reservation time of the interview according to the operation of the customer. The staff terminal 20 also accesses the information processing device 100 (S202). For example, the staff terminal 20 accesses the information processing device 100 by accessing a URL for conducting the interview at the reservation time of the interview by the operation of the staff. Then, the communication control unit 110 establishes communication between the customer terminal 10 and the staff terminal 20 (S203). That is, the communication control unit 110 achieves a call between the customer terminal 10 and the staff terminal 20.

Then, by the operation of the staff, the staff terminal 20 requests display control (S204). The display control unit 120 of the information processing device 100 controls the display of the customer terminal 10 in response to a request from the staff terminal 20 (S205). The displayed content includes information to be confirmed by the customer according to the content of the transaction, an input form that prompts the customer to perform various inputs, and the like. Here, it is assumed that the display control unit 120 causes the customer terminal 10 to display an input form for inputting a withdrawal amount of money desired by the customer (that is, a designated amount) as illustrated in FIG. 6. At this time, the customer terminal 10 receives an input to the input form (S206). For example, the customer terminal 10 receives an input of an amount of 1 million yen as the designated amount. The customer terminal 10 transmits the input information to the information processing device 100.

The acquisition unit 1100 acquires transaction information (S207). Specifically, the acquisition unit 1100 acquires information indicating the designated amount transmitted from the customer terminal 10 as the transaction information. At this time, the transaction information may further include customer identification information and an account number of the customer.

Then, the staff terminal 20 requests the business system 200 to transfer funds according to the transaction content (S208). In this example, the staff terminal 20 requests the business system 200 to transfer funds by the operation of the staff. The request indicates that 1 million yen is to be withdrawn from the account (savings account) indicated in the account number of the customer. At this time, the staff terminal 20 may transmit the transaction information to the business system 200 as a request. The present invention is not limited to this example, and the transaction information may be transmitted from the information processing device 100 to the business system 200 in response to acquisition of the transaction information by the acquisition unit 1100.

The control unit 1200 of the business system 200 instructs the backbone system 300 to transfer the fund from the first account to the second account in response to the request (S209). Specifically, the control unit 1200 issues an instruction to transfer 1 million yen from the account indicated by the account number of the customer to the second account based on the transaction information.

Upon receiving the instruction to transfer the fund from the business system 200, the account generation unit 310 of the backbone system 300 generates the second account associated with the customer (S210). More specifically, the account generation unit 310 registers the information of the second account in the customer registration information in association with the customer identification information. The setting unit 320 sets a password in the second account (S211). For example, the setting unit 320 generates character string information, and registers the generated character string information as a password of the second account in the customer registration information.

Then, the account management unit 330 reflects the operation related to the account on the accounting system 400 (S212). Specifically, the account management unit 330 reflects, in the accounting system 400, that the second account has been generated and that the password has been set in the second account. The account management unit 330 transfers the fund in accordance with the instruction. For example, the account management unit 330 performs control for causing the accounting system 400 to update the balance of the first account (savings account) of the customer to a value obtained by subtracting 1 million yen from the balance, and to update the balance of the second account of the customer to a value obtained by increasing the balance by 1 million yen. When the transfer of the fund is completed, the account management unit 330 notifies the business system 200. At this time, the account management unit 330 transmits the password of the second account to the business system 200.

The control unit 1200 notifies the staff terminal 20 and the information processing device 100 that the transfer of funds has been completed (S213). At this time, the control unit 1200 transmits the password of the second account to the information processing device 100.

The notification unit 1300 of the information processing device 100 notifies the customer of the password of the second account (S214). Specifically, the notification unit 1300 causes the customer terminal 10 to display information accessible to the password. For example, the notification unit 1300 causes the customer terminal 10 to display a two-dimensional barcode accessible to the password as illustrated in FIG. 8.

### [Payment Phase]

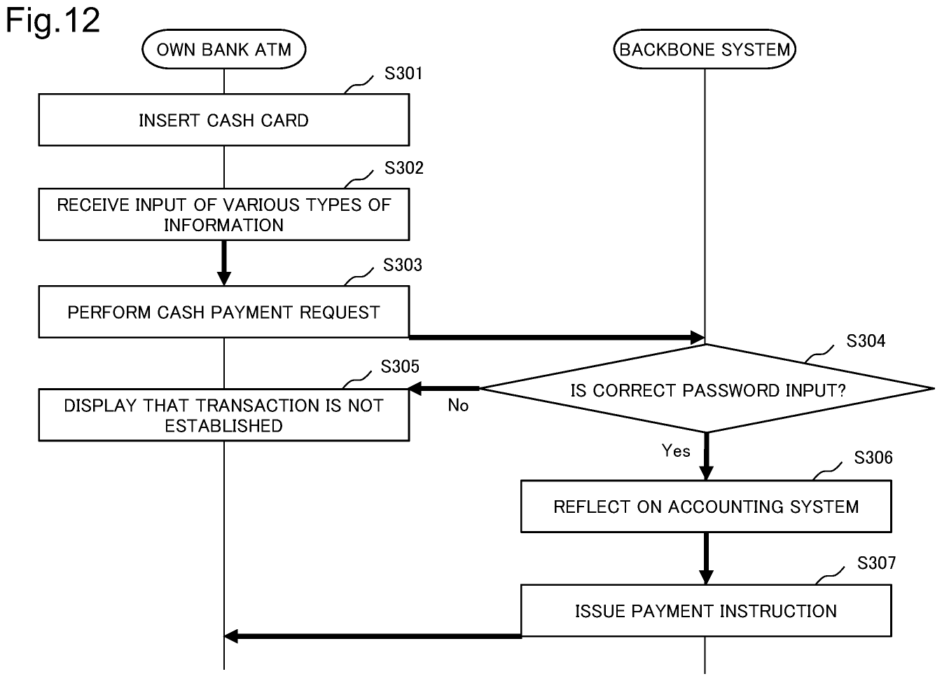

Next, an operation of the transaction support system 1000 in the payment phase will be described. The payment phase is a scene where a customer receives a fund generated by a transaction performed via a network using an ATM or the like. In the present operation example, an example in which a customer withdraws cash from the second account using the own bank ATM 30 will be described. FIG. 12 is a sequence diagram for explaining an example of the operation of the transaction support system 1000 in the payment phase.

First, a cash card is inserted into the own bank ATM 30 (S301). Typically, the customer has a cash card for the first account. By inserting the cash card, the account number of the first account of the customer is input to the own bank ATM 30.

Next, the own bank ATM 30 receives inputs of various types of information (S302). At this time, the customer may input selection of an account to be a transaction target to the own bank ATM 30. As a result, the own bank ATM 30 receives an input of an account that is a target of a transaction intended by the customer, such as the “first account” and the “second account”. A customer's intended transaction such as “deposit”, “withdrawal”, and “transfer” is input to the own bank ATM 30 by the customer's operation. In this example, “withdrawal” is input. An amount of money to be traded, a password, and the like are input to the own bank ATM 30 according to the operation of the customer. In this example, an amount of 1 million yen and a password of the second account are input.

In the processing of S302, the passcode of the first account may be input. That is, after the cash card is inserted in the processing of S301, the own bank ATM 30 may receive the input of the passcode of the first account. Here, when the correct passcode is not input, the own bank ATM 30 may perform the process again from the process of S301. When the correct passcode is input and the second account exists, the own bank ATM 30 may receive an input indicating whether the target of the transaction intended by the customer is the “first account” or the “second account” from the customer. Then, when the “second account” is selected (that is, when the customer desires a transaction targeting the second account), the own bank ATM 30 may receive the input of the information on the transaction intended by the customer, the information on the amount of money to be transacted, and the password related to the second account as described above.

After the processing of S302, the own bank ATM 30 makes a cash payment request to the backbone system 300 (S303). At this time, the own bank ATM 30 transmits the input various types of information (purpose of transaction, amount of money to be transacted, and password) to the backbone system 300.

The account management unit 330 of the backbone system 300 compares the transmitted password with the password registered in the customer registration information to check whether the correct password has been input. When the correct password has not been input (“No” in S304), the own bank ATM 30 is notified of the fact. Then, the own bank ATM 30 displays that the transaction is not established (S305). For example, the fact that the correct password has not been input is displayed on the display of the own bank ATM 30.

When the correct password is input (“Yes” in S304), the account management unit 330 reflects the contents of the transaction in the accounting system 400 (S306). Specifically, the account management unit 330 performs control to cause the accounting system 400 to update the balance of the second account of the customer to a value obtained by subtracting 1 million yen. Then, the account management unit 330 issues a payment instruction to the own bank ATM 30 (S307).

### [Effects of Transaction Support System 1000]

As described above, the transaction support system 1000 according to the second example embodiment serves as at least a part of a system in which a staff of a financial institution and a customer can perform a financial transaction via a network. Then, the transaction support system 1000 acquires the transaction information including the information of the designated amount which is the amount of money designated in the transaction, controls to transfer the designated amount of fund indicated in the transaction information from the first account of the customer to the second account, and notifies the customer of the password required for paying out cash from the second account.

As a result, the transaction support system 1000 can cause the customer to pay out cash with the password notified at the time of performing the transaction, so that the identity between the customer who applies for the transaction and the customer who receives the cash can be secured. Furthermore, the fund of the second account is the fund generated in the transaction. That is, when cash is paid out to the customer, the transaction support system 1000 can cause the customer to more reliably recognize that the cash is the fund generated by the transaction performed via the network. That is, in a case where a financial transaction is performed via a network, the transaction support system 1000 can support appropriate payment of the fund generated in the transaction to the customer.

The transaction support system 1000 according to the second example embodiment may generate character string information in response to the generation of the second account and set the generated character string information as the password of the second account. Accordingly, since the password set to the second account is a newly generated password, the transaction support system 1000 can suppress reuse of the password by the customer.

When notifying the customer of the password, the transaction support system 1000 of the second example embodiment may cause the customer terminal 10 used by the customer to display information that is obtained by converting the password and that can access the password. Accordingly, since the information indicating the password itself is not displayed on the customer terminal 10, the transaction support system 1000 can suppress leakage of the password due to peeping of the customer terminal 10 by another person.

The transaction support system 1000 according to the second example embodiment may control communication for connecting the customer terminal 10 and the staff terminal 20, and may display an input form for accepting input of a designated amount on the customer terminal 10 in response to a request from the staff terminal 20. As described above, in the transaction support system 1000, since the staff side can perform necessary procedures and the like, it is not necessary for the customer to perform the operation until the transaction is established.

### [Modification 1]

The business system 200 and the backbone system 300 may be treated as an integrated system. That is, the processing of the control unit 1200, the account generation unit 310, the setting unit 320, and the account management unit 330 may be performed in an integrated system.

### [Modification 2]

In the second example embodiment, the example in which the character string information generated by the setting unit 320 is set as the password of the second account has been described, but the method of setting the password is not limited to this example. For example, character string information input by the customer in the customer terminal may be set as the password of the second account.

Specifically, in the processing of S205 of FIG. 11, the display control unit 120 causes the customer terminal 10 to display an input form for inputting not only the designated amount but also character string information to be a password. As a result, the acquisition unit 1100 acquires the designated amount and the character string information as the transaction information in the processing of S207. In the processing of S209, the control unit 1200 also transmits character string information to the backbone system 300. Then, in the processing of S211, the setting unit 320 sets the input character string information as the password of the second account.

As described above, the transaction support system 1000 of Modification 2 acquires the character string information input in the customer terminal 10, and transmits the character string information when issuing an instruction to transfer from the first account to the second account. Then, the transaction support system 1000 sets the transmitted character string information as the password of the second account.

### [Modification 3]

In the second example embodiment, an example in which a request for transfer of funds is made by a staff who has an interview with a customer has been described, but the request is not limited to the example described here.

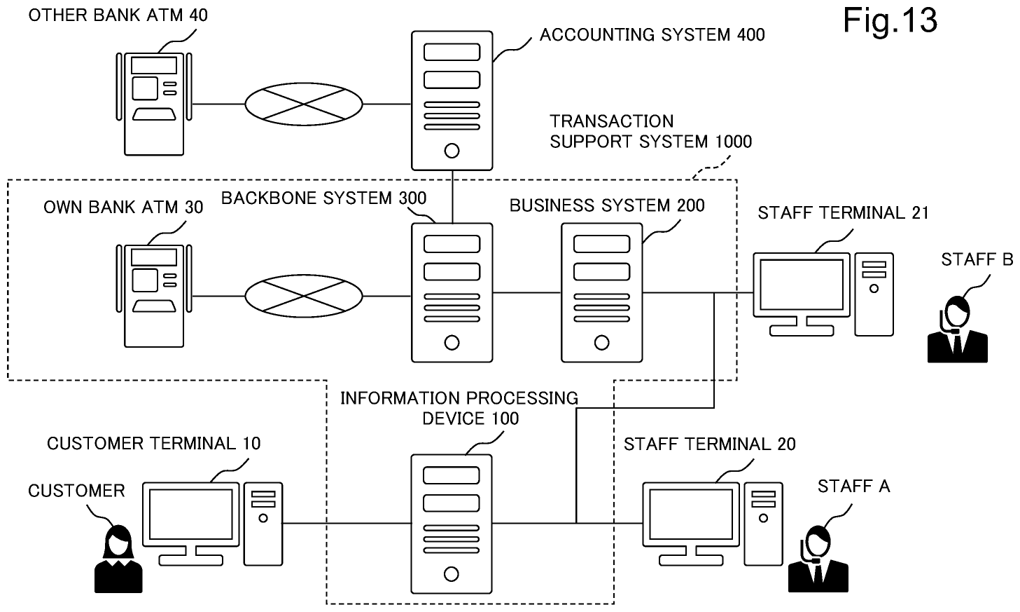

FIG. 13 is a diagram schematically illustrating an example of a configuration including the transaction support system 1000 of Modification 3. In the example of FIG. 13, there is a staff terminal 21 that can communicate with the information processing device 100 and the staff terminal 20. The staff terminal 21 is communicably connected to the business system 200. In this example, the staff terminal 20 is used by a staff A. The staff A is, for example, an operator who has an interview with a customer. The staff terminal 21 is used by a staff B. The staff B is, for example, a clerical staff who performs various inputs to the system.

In this case, for example, after the processing of S207 in FIG. 11, the acquisition unit 1100 transmits the transaction information to the staff terminal 21. The processing of S208 is performed in the staff terminal 21. Then, the processing of S213 is performed in the instruction by the staff terminal 21.

### [Modification 4]

In the second example embodiment, an example of acquiring personal information of a customer by inputting an account number or the like in a reservation form in the reservation phase has been described. The method for acquiring personal information is not limited to this example.

For example, in the processing of S101 of FIG. 10, the customer logs in to a website or the like of a financial institution from the customer terminal 10. In this case, personal information such as a name, an account number, a telephone number, and an e-mail address of the customer is registered in advance. Therefore, in the processing of S103, the customer only needs to input the purpose of the transaction, the reservation time for the interview, and the like. Then, the acquisition unit 1100 acquires the input information and the personal information of the customer associated with the login information in the processing of S104.

The present invention is not limited to this example, and the transaction support system 1000 may acquire personal information in a transaction phase, for example. In this case, in the processing of S205 of FIG. 11, the display control unit 120 causes the customer terminal 10 to display an input form for inputting personal information such as the name, account number, telephone number, and e-mail address of the customer. Then, the personal information is input in the processing of S206. As a result, in the processing of S207, the acquisition unit 1100 acquires personal information in addition to the transaction information.

### [Modification 5]

In the second example embodiment, in the reservation phase, a URL for conducting an interview is notified to the customer. The customer has an interview with the staff by using the URL. As described above, the transaction support system 1000 can perform customer identification when starting a transaction via the network by causing the customer to access the URL.

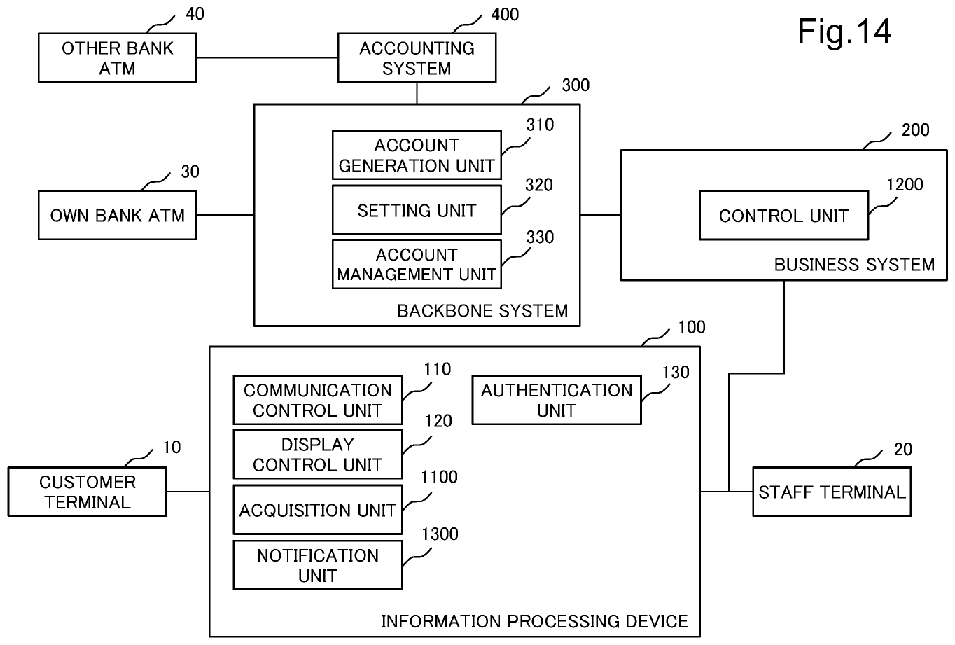

On the other hand, customer identification may be performed in another form. FIG. 14 is a block diagram illustrating an example of a configuration of the transaction support system 1000 of Modification 5. In the example of FIG. 14, the information processing device 100 further includes an authentication unit 130.

The authentication unit 130 has a function of authenticating a customer. The authentication unit 130 is an example of an authentication means. Specifically, in the transaction phase, the acquisition unit 1100 acquires the biological information of the customer from the customer terminal 10. The biological information is, for example, information indicating features such as a face, a fingerprint, an iris, and a vein of the customer. The authentication unit 130 performs customer identification based on the acquired biological information. At this time, the information processing device 100 has a database in which the customer identification information and the biological information of the customer are associated with each other. The authentication unit 130 collates the acquired biological information with the biological information registered in the database. When the collation is matched, the authentication unit 130 determines that the customer in the transaction is the same person as the customer who has reserved the interview (is a correct customer). That is, the authentication unit 130 authenticates the customer.

An operation example of a process of authenticating a customer will be described with reference to the example of FIG. 11. In the present operation example, an example in which information indicating a facial feature is used as the biological information will be described.

After the processing of S201 in FIG. 11, the display control unit 120 performs display for prompting the input of the biological information on the customer terminal 10. For example, the display control unit 120 displays “Face the camera” on the customer terminal 10. Then, when the face image of the customer is photographed in the customer terminal 10, the acquisition unit 1100 acquires the photographed image from the customer terminal 10. Then, the authentication unit 130 collates the face image registered in the database in which the customer identification information and the face image of the customer are associated with each other with the face image acquired by the acquisition unit 1100. When the collation is matched, the authentication unit 130 authenticates the customer. Thereafter, the processing in and after S203 is performed.

In the present operation example, in a case where information other than the information indicating the facial feature is used as the biological information, it is assumed that the customer terminal 10 has a device capable of capturing the information.

As described above, the transaction support system 1000 of Modification 5 may acquire the biological information of the customer from the customer terminal 10 and authenticate the customer based on the acquired biological information and the biological information registered in the database. As a result, the transaction support system 1000 can more reliably perform customer identification.

The transaction support system 1000 may authenticate the customer using the passcode of the first account instead of the biological information.

### [Modification 6]

The customer terminal 10 may not be a device owned by a customer. The customer terminal 10 may be installed in a store of a financial institution. In this case, for example, the customer terminal 10 may be installed in a dedicated booth partitioned in the store of the financial institution.

### [Modification 7]

In the second example embodiment, the example in which the customer uses the own bank ATM 30 has been mainly described for the payment phase, but cash can be paid using the other bank ATM 40.

For example, the processing of S301, S302, S303, and S305 in FIG. 12 may be performed by the other bank ATM 40 of the other bank, and the processing of S304, S306, and S307 may be performed by the accounting system 400.

For example, the processing of S301, S302, S303, and S305 of FIG. 12 may be performed by the other bank ATM 40, and the processing of S304, S306, and S307 may be performed by a server or the like (not illustrated) communicably connected to the other bank ATM 40. The server or the like may acquire information regarding the second account of the customer from the backbone system 300 or the accounting system 400.

### [Modification 8]

As described above, the transaction support system 1000 handles the fund generated by the transaction in the second account. As a result, the transaction support system 1000 can make the service for handling the first account and the service for handling the second account different from each other.

An example of the service is setting of a payout upper limit amount. A payout upper limit amount may be set for withdrawal of cash from a savings account using an ATM. For example, in the case of using an ATM, it is assumed that payout is limited within 300,000 yen per day. In this case, when the customer desires to withdraw 1 million yen in cash, the customer needs to use the ATM a plurality of times over several days or apply for withdrawal at a counter of a financial institution.

On the other hand, the transaction support system 1000 handles the fund generated by the transaction in the second account other than the first account. Therefore, the transaction support system 1000 can perform an operation of setting the payout upper limit amount for the payment of cash from the first account and changing the payout upper limit amount for the payment of cash from the second account.

Specifically, the account management unit 330 sets the payout upper limit amount for the payment of cash from the second account to be higher than the payout upper limit amount required for the payment of cash from the first account. At this time, the account management unit 330 may not set the payout upper limit amount for the payment of cash from the second account.

An example of the service is setting of a fee. When cash is withdrawn from a savings account using an ATM, a certain fee may be required. At this time, when the customer tries to withdraw the same amount of money as the designated amount from the ATM from the savings account, the customer needs to pay a fee.

On the other hand, the transaction support system 1000 handles the fund generated by the transaction in the second account other than the first account. Therefore, the transaction support system 1000 can perform an operation in which a fee required for paying out cash from the first account is different from a fee required for paying out cash from the second account.

Specifically, the account management unit 330 sets the fee required for paying out cash from the second account to be different from the fee required for paying out cash from the first account. At this time, the account management unit 330 may set the fee required for withdrawal from the second account to 0 yen.

In this manner, the account management unit 330 may set the service for handling the first account and the service for handling the second account to be different from each other.

### <Configuration Example of Hardware of Transaction Support System>

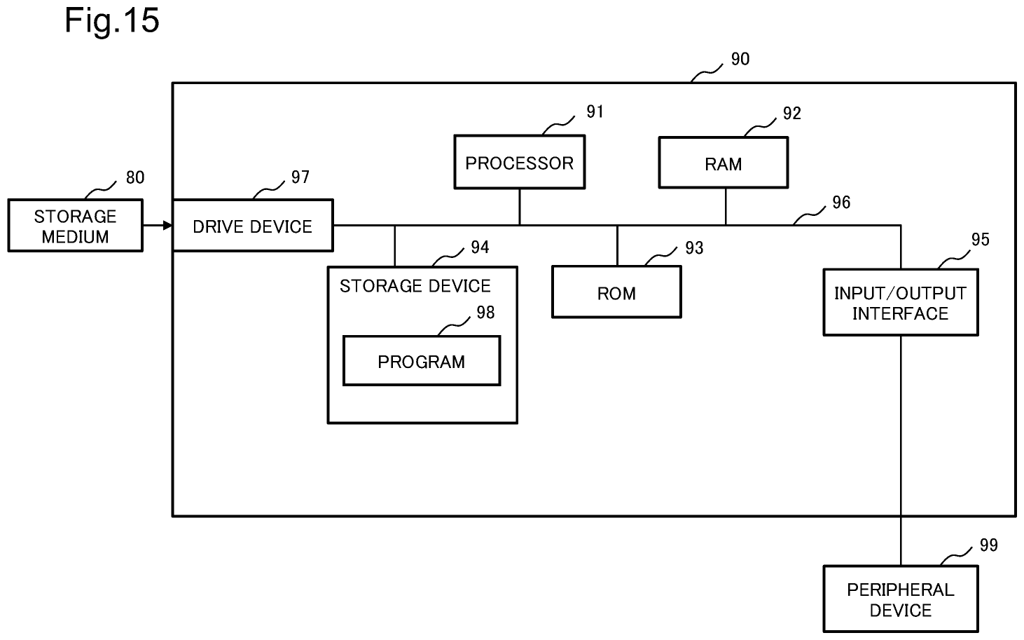

Hardware constituting the above-described first and second example embodiments of the transaction support system will be described. FIG. 15 is a block diagram illustrating an example of a hardware configuration of a computer device that implements the transaction support system according to each example embodiment. In a computer device 90, the transaction support system and the transaction support method described in each example embodiment and each modification are achieved. For example, each of the information processing device, the business system, the backbone system, and the like described in each example embodiment and each modification may have the hardware configuration illustrated in FIG. 15.

As illustrated in FIG. 15, the computer device 90 includes a processor 91, a random access memory (RAM) 92, a read only memory (ROM) 93, a storage device 94, an input/output interface 95, a bus 96, and a drive device 97. The transaction support system may be implemented by a plurality of electric circuits.

The storage device 94 stores a program (computer program) 98. The processor 91 executes the program 98 of the present transaction support system using the RAM 92. Specifically, for example, the program 98 includes a program that causes a computer to execute the processing of the signal processing device described in FIGS. 3, 10, 11, and 12. The processor 91 executes the program 98 to implement the functions of the components of the present transaction support system. The program 98 may be stored in the ROM 93. The program 98 may be recorded in the storage medium 80 and read using the drive device 97, or may be transmitted from an external device (not illustrated) to the computer device 90 via a network (not illustrated).

The input/output interface 95 exchanges data with a peripheral device (keyboard, mouse, display, etc.) 99. The input/output interface 95 functions as a means for acquiring or outputting data. The bus 96 connects the components

There are various modifications of the method for implementing the transaction support system. For example, each configuration included in the transaction support system can be achieved as a dedicated device. The transaction support system each can be implemented based on a combination of a plurality of devices.

Processing methods for causing a storage medium to record a program for implementing configurations in a function of each example embodiment, reading the program recorded in the storage medium as a code, and executing the program in a computer are also included in the scope of each example embodiment. That is, a computer-readable storage medium is also included in the scope of each example embodiment. A storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program that executes processing alone, and programs that operate on an operating system (OS) to execute processing in cooperation with other software and functions of an extension board are also included in the scope of each example embodiment.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims.

The above-described example embodiments and modifications can be appropriately combined.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

1. A transaction support system comprising:
one or more memories storing instructions; and
one or more processors configured to execute the instructions to:
acquire transaction information including information about a designated amount, the designated amount being an amount of money designated in a financial transaction through a network;
control to transfer the designated amount of fund in the acquired transaction information from a first account to a second account of a customer of the financial transaction; and
notify the customer of a password required for paying out cash from the second account.

2. The transaction support system according to claim 1, wherein
the one or more processors are configured to execute the instructions to:
issue an instruction to transfer the designated amount of fund from the first account to the second account,
wherein anther one or more processors are configured to execute the instructions to:
generate the second account associated with customer identification information for identifying the customer according to the instruction; and
transfer the designated amount of fund from the first account to the generated second account.

3. The transaction support system according to claim 2, wherein
the one or more processors are further configured to execute the instructions to:
generate character string information in response to generation of the second account; and
set the generated character string information as the password of the second account.

4. The transaction support system according to claim 2, wherein
the one or more processors are further configured to execute the instructions to:
acquire character string information input in a customer terminal used by the customer;
instruct to set the character string information to the password of the second account when the instruction to transfer the designated amount of fund is issued, and
wherein anther one or more processors are configured to execute the instructions to:
set the character string information as the password of the second account.

5. The transaction support system according to claim 1, wherein
the one or more processors are further configured to execute the instructions to:
convert the password to a conversion information; and
display the conversion information on a display of a customer terminal used by the customer.

6. The transaction support system according to claim 2, wherein
the one or more processors are further configured to execute the instructions to:
convert the password to a conversion information; and
display the conversion information on a display of a customer terminal used by the customer.

7. The transaction support system according to claim 3, wherein
the one or more processors are further configured to execute the instructions to:
convert the password to a conversion information; and
display the conversion information on a display of a customer terminal used by the customer.

8. The transaction support system according to claim 4, wherein
the one or more processors are further configured to execute the instructions to:
convert the password to a conversion information; and
display the conversion information on a display of a customer terminal used by the customer.

9. The transaction support system according to claim 1, wherein
the one or more processors are further configured to execute the instructions to:
control communication for connecting a customer terminal used by the customer and a staff terminal used by a staff of the financial transaction; and
display an input form for receiving an information of the designated amount, on the customer terminal, in response to a request from the staff terminal.

10. The transaction support system according to claim 9, wherein
the one or more processors are further configured to execute the instructions to:
acquire a biological information of the customer from the customer terminal; and
authenticate the customer using the acquired biological information and a biological information registered in a database.

11. The transaction support system according to claim 1, wherein
the one or more processors are further configured to execute an instruction to set a fee required for paying out cash from the second account to be different from a fee required for paying out cash from the first account.

12. A transaction support method comprising:
acquiring transaction information including information of a designated amount, the designated amount being an amount of money designated in a financial transaction through a network;
controlling to transfer the designated amount of fund in the acquired transaction information from a first account to a second account of a customer of the financial transaction; and
notifying the customer of a password required for paying out cash from the second account.

13. A non-transitory recording medium having stored therein a program for causing a computer to execute:
acquiring transaction information including information of a designated amount, the designated amount being an amount of money designated in a financial transaction through a network;
controlling to transfer the designated amount of fund in the acquired transaction information from a first account to a second account of a customer of the financial transaction; and
notifying the customer of a password required for paying out cash from the second account.
